(19) United States
(12) Patent Application Publication
(10) Pub. No.: US 2002/0195460 A1
(43) Pub. Date: Dec. 26, 2002

(54) Container for receiving and dispensing a fluid medium

(76) Inventors: Hans-Martin Kapsa, Ottersweier (DE); Wilhelm Werhahn, Baden-Baden (DE); Werner Panter, Achern (DE)

Correspondence Address: COLLARD & ROE, P.C., 1077 Northern Boulevard, Rosslyn, NY, 11576-1696, US

(21) Appl. No.: 10/156,681

(22) Filed: May 28, 2002

(30) Foreign Application Priority Data
May 29, 2001 (DE) 101 26 098.9

(51) Int. Cl. B67D 5/00

(52) U.S. Cl. 222/83

(57) ABSTRACT

A container for receiving and dispensing a fluid medium, in particular adhesive, comprises a container opening that is sealed by means of a membrane that can be pierced; a dispensing tube that can be connected with the container via the container opening for dispensing the fluid medium; and a screw cap for sealing the dispensing tube. There is a dispensing tube holder fixed on the container housing, in which the dispensing tube is axially supported between a starting position, in which its lower end is resting above the membrane to be pierced, and an axially blocked end position, in which its lower end has pierced the membrane. There is a servo-drive integrated in the screw cap for the dispensing tube. The servo-drive translates a rotational motion for opening the screw cap into a movement for displacing the dispensing tube into its end position.

### BACKGROUND OF THE INVENTION

1. Field of the Invention

The invention relates to a container for receiving and dispensing a flowing medium such as adhesive, comprising a container opening, which is sealed by means of a membrane that can be pierced; a dispensing tube that can be connected with the container for dispensing the flowing medium via the opening of the container; and a screw cap for sealing the dispensing tube.

2. The Prior Art

With such a container, the membrane sealing the opening of the container reliably protects the contents of the container against unintentional discharge of the medium until it is dispensed for the first time. The membrane has to be pierced before the medium is dispensed from the container for the first time. For example, a container of the type specified above is known for the specified purpose. This known container has a mandrel integrated in its screw cap. After the dispensing tube has been unscrewed from the container, the membrane is pierced with the mandrel, whereupon the dispensing tube is screwed to the container as intended. The dispensing tube is then sealed again with the screw cap after flowing medium contained in the container has been dispensed. This design of the conventional container requires relatively complicated manual intervention by the user before fluid medium can be dispensed from the container for the first time.

Once the membrane has been pierced by hand, it is not possible to prevent the medium from leaking from the container, which can be very unpleasant if the medium is an adhesive that sets in seconds.

### SUMMARY OF THE INVENTION

It is therefore an object of the present invention to provide a container of the type specified above that assures the user of accessing the content of the container for the first time by simple means.

The invention provides a servo-drive for the dispensing tube that is integrated in the screw cap of the container. Within the framework of the usual procedure applied for unscrewing the screw cap, the servo-drive automatically pierces the membrane sealing the opening of the container. The dispensing tube permanently takes up its intended position in the opening of the container as intended after the screw cap has been completely unscrewed. This means that no complicated manipulations are required to unscrew the cap, then pierce the membrane by hand, and then screw the dispensing tube to the container. Therefore, the invention provides a container of the type specified above that can be used like a container not having a container opening that is initially sealed by a membrane, by simply unscrewing the screw cap in order to dispense fluid medium from the container. The unscrewing movement is exploited for automatically piercing the membrane and positioning the dispensing tube.

In detail, a dispensing tube holder is provided. In this holder, the dispensing tube is supported in an axially displaceable manner between a starting position, where it rests with its lower end positioned above the membrane that has to be pierced, and an axial, blocking final position, where its lower end has pierced the membrane. Furthermore, there is a servo-drive for the dispensing tube that is integrated in the screw cap. For opening the screw cap, the servo-drive translates a rotational motion into a movement for displacing the dispensing tube, moving it into its end position.

With the dispensing tube in the end position, the blockage preferably takes place via a locking means for retaining the dispensing tube in this position. This locking means may be an annular bead in the area of the lower end of the dispensing tube that engages the opening of the container from behind as soon as the dispensing tube is located in its end position, in which it has pierced the membrane.

The servo-drive for the dispensing tube can be realized in different ways. According to a preferred embodiment of the invention, the integrated servo-drive is formed as a type of sliding block drive that translates the rotational opening motion used for unscrewing the screw cap, into an axial actuation movement for the dispensing tube, so that the latter is moved downwards in relation to the membrane against the axial upward movement of the screw cap and is pierced, and then axially fixed in its end position in the opening of the container.

According to a preferred embodiment of the servo-drive of the container as defined by the invention, the dispensing tube is supported in the dispensing tube holder with torsional strength, and the servo-drive comprises a multitude of coaxially arranged components. These components comprise a first screw cap component, which engages with its thread a thread fixed on the container; a second screw cap component, which is rotatingly connected with the first screw cap component and axially fixed; and a sliding component for displacing the dispensing tube that is axially acting in the direction of the membrane and in engagement with the second screw cap component via its thread. For axially displacing the dispensing tube by translating the rotational motion of the second screw cap component into a stroke movement, the sliding component is arranged with torsional strength in relation to the second screw cap component. The thread connection between the second screw cap component and the sliding component displacing the dispensing tube has a thread direction, which, in relation to the thread connection of the first component of the screw cap having the thread fixed on the housing, opposes the direction of the latter thread.

The component shifting the dispensing tube has a coupling for tying it with torsional strength to the first screw cap component in order to form a closed, assembled unit jointly with the first and second screw cap components that are axially fixed on one another. This assembled, closed unit can be unscrewed from the thread fixed on the container when the dispensing tube is in its end position.

In other words, according to a preferred embodiment of the servo-drive as defined by the invention, a two-component cap is used, whereby a first component of the screw cap has the function of retaining the two-component screw cap on the container until the dispensing tube has taken up its end position, in which it has pierced the membrane that has initially sealed the opening of the container. The second component of the screw cap is supported in a freely rotating and axially undisplaceable manner on the first component of the screw cap, and forms a driving means for a component displacing the dispensing tube, with which it is engaged via a thread connection. This thread connection between the second component of the screw cap and the component shifting the dispensing tube runs counter to the thread with which the first component of the screw cap is screwed to the container, i.e. typically with a left-hand thread. In this way, in the course of the normal screw-on movement, i.e. by turning the second component of the screw cap counterclockwise, (=normal direction of rotation for unscrewing the cap from the opening), the dispensing tube holder is driven clockwise, lowering the dispensing tube. This thread connection, which is partly fixed in terms of rotation, for translating an externally applied rotational movement into an axial lifting movement of the component displacing the dispensing tube, said component being disposed on the inside, may be replaced also by a bayonet arrangement that has a locking function at the same time, or also by steep cams, in other words, by a moving block-type drive.

The two components of the screw cap are assembled with the component shifting the dispensing tube only after the dispensing tube has been completely shifted into its end position by the component displacing it, so that these three components are jointly actuated like a single-piece screw cap. This assembled screw cap unit is now detached from the container like a conventional single-component screw cap as it is being unscrewed further from the container in the counterclockwise direction. The dispensing tube, which is firmly seated in the container opening, is now freely accessible for dispensing fluid medium from the container.

The combination of the two screw components of the container with the component displacing the dispensing tube is preferably designed for a permanent assembly, so that these components forming the screw cap by their entirety can now always be handled just like a normal screw cap.

The two-component structure of the screw cap is preferably not disclosed to the user of the cap that is formed as defined by the invention, i.e. the user has the impression of handling a normal screw cap, the reason being that the second component of the screw cap preferably completely encloses the first component of the screw cap that is screwed to the container, so that the user has no reason for manipulating the screw cap part, which is the only one accessible to him, in any way other than he would manipulate a normal screw cap, namely by turning it counterclockwise in order to unscrew it.

The preferred embodiment of the servo-drive for the dispensing tube explained above is based on supporting the dispensing tube in the dispensing tube holder in such a way that it cannot be rotated. There is a form-locked connection between the dispensing tube holder and the dispensing tube for such a support, in which the latter is fixed against rotation. For this purpose, the dispensing tube is advantageously provided with a multi-edged section extending through a corresponding multi-edged passage in the dispensing tube holder.

The thread fixed on the container, with which the thread of the first component of the screw cap is engaged until the assembled unit of the components of the cap is unscrewed, is a male thread formed on the dispensing tube holder.

The second component of the screw cap, which completely surrounds the first component of the screw cap, so that only the second component of the screw cap is visible from the outside as the cap that can be turned, is connected in a rotating manner with the first component of the screw cap, preferably via an annular groove and an annular bead.

The component displacing the dispensing tube is preferably completely contained in the second component of the screw cap, and has a male thread that is engaged with a female thread of the second component of the screw cap. There is a form-locked joint between the component displacing the dispensing tube and the dispensing tube, for supporting the former with torsional strength. This form-locked joint preferably comprises a multi-edged section, for example the same multi-edged section of the dispensing tube that effects the support of the component displacing the dispensing tube with torsional strength as well. This multi-edged section is engaged with clamping elements of the component displacing the dispensing tube. Since this form-locked connection has to be overcome for unscrewing the assembled arrangement comprising the components of the cap and the component displacing the dispensing tube after the dispensing tube has taken up its end position, the form-locked connection is formed in such a way that for unscrewing this assembled unit, this connection can be overcome by realizing the clamping elements of the component displacing the dispensing tube in the form of yielding elements.

As explained above, the two screw cap components are assembled with the component displacing the dispensing tube via a coupling means between the component displacing the dispensing tube and the first component of the screw cap. This coupling is preferably realized in the form of an axially locking toothing. So as to assure a permanent joint of the combined unit, there is a device for axially fixing the component displacing the dispensing tube on the first component of the screw cap when the coupling is engaged, the purpose being to connect these two components with torsional strength. This device for axially fixing the component displacing the dispensing tube on the first component of the screw cap is preferably formed by a locking means. This locking means may comprise, for example, hooks or locking noses on the first component of the screw cap that engage a corresponding groove on the component displacing the dispensing tube so as to permanently connect these two components with each other. The permanent joint between the two sliding components of the cap is made available by the rotational connection of these two components. Such a rotational connection assumes a blocking position as soon as the first component of the screw cap has been permanently joined with the components displacing the dispensing tube. In other words, in this condition, the second component of the screw cap is fixed on the first component of the screw cap not only axially, but in terms of rotation as well.

As stated above, the second component of the screw cap preferably has the shape of a conventional screw cap, for example in the form of a cup. It is preferred in that case that the component displacing the dispensing tube has the shape of a cup as well, and that the generally cylindrical first component of the screw cap adjoins the edge of the cup forming the component displacing the dispensing tube. The aforementioned clamping elements, which jointly with the multi-edged section of the cap form the form-locked connection between the dispensing tube and the component displacing the latter for supporting the component displacing the dispensing tube with torsional strength, project from the bottom of the cup in the form of a clamping bush. With their free ends, these clamping elements engage the multi-edged section of the dispensing tube. The free ends of the clamping bush act upon a dish of the dispensing tube, which is integrated in the dispensing tube so that the annular edge of this dish protrudes radially in order to be able to lower the dispensing tube into its final position in the opening of the container, which is accomplished by rotating the second component of the screw cap. Instead of using the clamping bush, it is possible also to employ another element that assures a torsionally fixed support for the component displacing the dispensing tube, and which can be highly expanded.

Furthermore, a closing pin for sealing the dispensing tube preferably protrudes from the bottom of the cup-shaped component displacing the dispensing tube. This pin closes the dispensing tube when the screw cap is mounted on the container by engaging the front end of the dispensing tube.

According to another preferred embodiment of the invention, the container is equipped with a protective safety device for children in the form of a cup-shaped external cover. This external cover completely projects over the cup-shaped second component of the screw cap and can be joined with the second component of the screw cap for rotating the latter by axially pressing the external cover against the second component of the screw cap. When this external cover is released, this connection with the second component of the screw cap is canceled again by a spring means that lifts the outer cover axially from the second screw cap and thereby cancels the connection between the outer cover and the screw cap.

A preferred application of the container as defined by the invention is for receiving and dispensing adhesive, especially fast-setting adhesives, which set in a matter of seconds.

### BRIEF DESCRIPTION OF THE DRAWINGS

Other objects and features of the present invention will become apparent from the following detailed description considered in connection with the accompanying drawings. It is to be understood, however, that the drawings are designed as an illustration only and not as a definition of the limits of the invention.

In the drawings, wherein similar reference characters denote similar elements throughout the several views:

FIG. 1 is a view of the container as defined by the invention for receiving and dispensing a flowing medium in the area of a screw cap that is formed by several components, whereby the outer cover and the dispensing end of the container are shown by a sectional view;

FIG. 2 is a view of the container as defined by the invention similar to FIG. 1, whereby the second component of the screw cap surrounded by the outer cover is additionally shown cut open;

FIG. 3 is a presentation similar to the one in FIG. 2, whereby the component displacing the dispensing tube is additionally shown cut open;

FIG. 4 is a view similar to the one in FIG. 3, whereby the first component of the screw cap is additionally shown cut open;

FIG. 5 is a view similar to the one of FIG. 4, but showing the dispensing tube completely shifted into its end position, and all components of the cap joined together with each other and with the component displacing the dispensing tube; and

FIG. 6 is a view similar to the one in FIG. 5, but showing the assembled screw cap unscrewed from the container.

### DETAILED DESCRIPTION OF THE PREFERRED EMBODIMENT

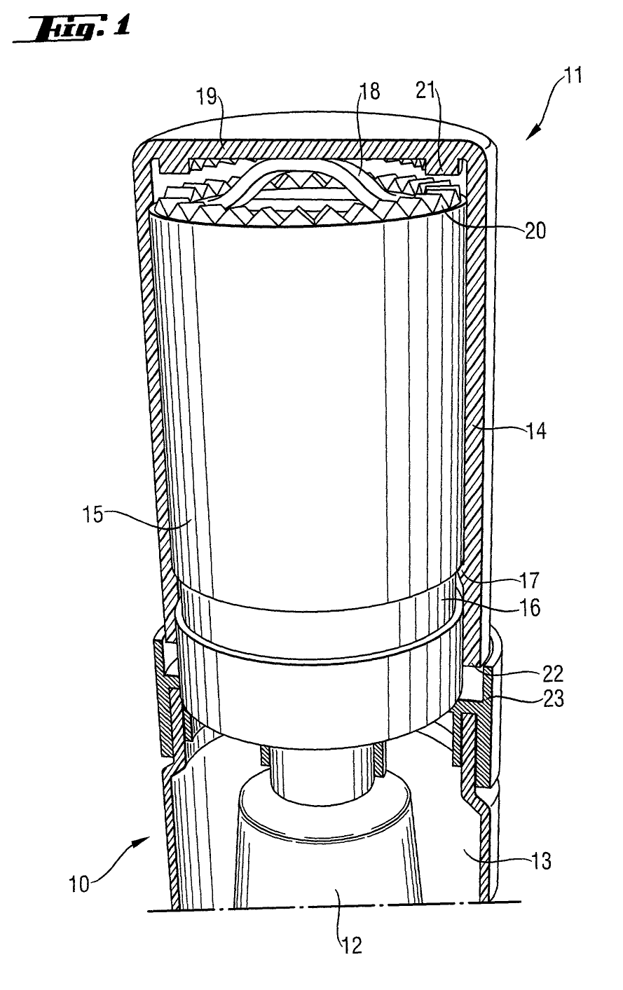

Referring now in detail to the drawings, FIG. 1 shows the container for receiving and dispensing a flowing medium, primarily adhesive, generally denoted by the reference numeral 10. The multi-component screw cap for sealing the container is generally denoted by the reference numeral 11. Container 10 comprises an inside container 12 containing the fluid medium. This inside container is firmly connected in an airtight manner with an outer container 13. Instead of using an inside container and an outside container, it is possible also to use in the conventional way only one single container for receiving a liquid medium. As already stated above, in the arrangement shown, inside container 12 forms the vessel for receiving the fluid medium, whereas outer container 13 is connected with inside container 12 via an intermediate arrangement of an air cushion. Inside container 12 can be indirectly compressed via this air cushion for dispensing the fluid medium.

The multi-component screw cap 11 comprises a cylindrical, cup-shaped outer cover 14, which completely encloses the actual screw cap of container 10, and jointly with the latter forms a safety device for children, which is explained in the following in greater detail.

Outer cover 14 is intended to prevent children from unauthorized access to the inside screw. For this purpose, outer cover 14 is connected in a freely rotating manner with the inside screw cap, and outer cover 14 is joined up with the inside screw cap by actuating it in the manner known per se, by axially displacing outer cover 14 against the inside screw cap, joining them together.

FIG. 1 shows a second screw cap component 15 of the inside screw cap that is shaped in the form of a cup as well. The outside diameter of said second component of the screw cap is coordinated with the inside diameter of the outer cover 14 so that outer cover 14 can be freely rotated in relation to the second component of the screw cap. For axially retaining outer cover 14 on the second component 15 of the screw cap in an undetachable manner, component 15 comprises an annular groove 16, which, in the embodiment shown, is formed in the area of the edge of the cup-shaped screw cap component 15. For engaging annular groove 16, an annular cam 17 extending all around is formed on the inside wall of outer cover 14. Cam 17 has a lesser axial expanse than annular groove 16, so that outer cover 14 is seated on second component 15 of the screw cap at the level of annular groove 16 in an axially displaceable manner, yet in a way such that it is inseparably connected with said second component via the engagement existing between the annular groove and the cam.

On the bottom of second screw cap component 15, a spring means in the form of a generally U-shaped, outwardly protruding bridge 18 is formed, realized as one piece with the bottom. This spring bridge is made of elastic material, preferably of the same plastic material used for forming second component 15 of the screw cap. The generally bow-shaped spring bridge 18 is shaped so that in the pressure-relieved condition, it retains ring-shaped cam 17 of outside cover 14 against the upper edge of annular groove 16 in the second screw cap component, by resting against the inner side of bottom 19 of outside cover 14.

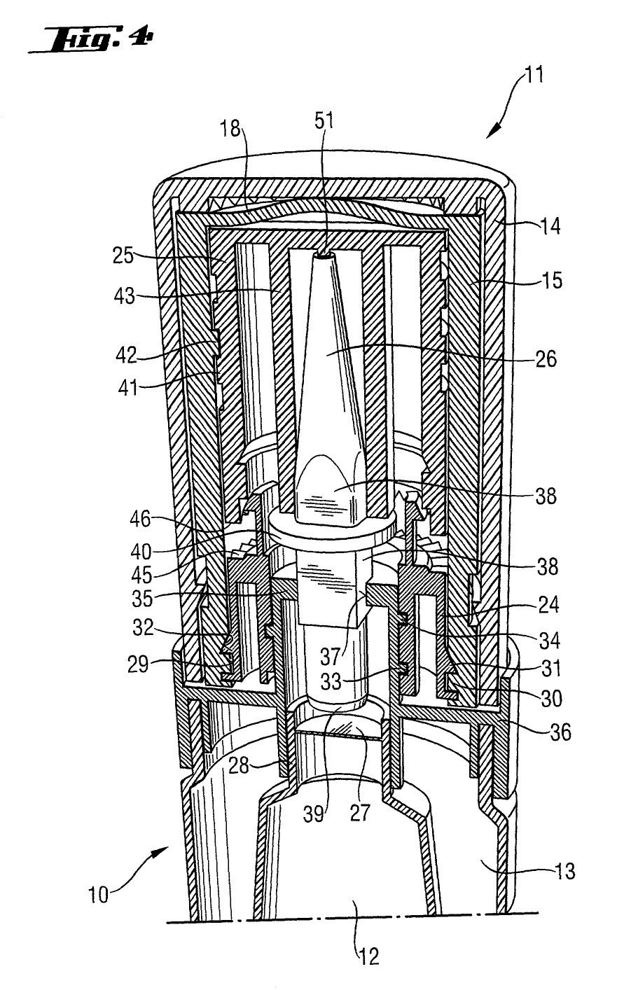

A coupling means comprising a toothed rim 20 located on the side of the screw cap part, and a toothed rim 21 located on the side of the outside container, is formed between the bottom of outside container 13 and second component 15 of the screw cap. These two toothed rims 20 and 21 have the same sequence and height of their teeth, and the height of the teeth is formed in such a way that the two toothed rims 20 and 21 will not engage each other under the action of spring bridges 18 as long as no axial force is applied to outside container 13 that would suffice for overcoming the curved shape inherent to the spring bridge 18, and for engaging toothed rims 20 and 21 with each other. In this retracted position of the coupling that is made available by toothed rims 20, 21 between outside container 13 and second component 15 of the screw cap (see FIG. 4), cam 17 of outside container 13 is located in the area of the lower edge of annular groove 16. As an alternative, instead of annular groove 16, a zone of the edge of the cup of the second screw cap component 15 can be made with a continuously reduced diameter, whereby in such a case, cam 17 comes to rest under the force of the spring against the shoulder between the two parts of the second screw cap component 15 having different diameters when no force directed axially downwards is applied to the outside cover 15.

Therefore, actuation of the screw cap part via the outside cover 14 is possible only by applying to the outside cover 13 not only a motion of rotation but also a downwards directed axial force. This provides a safety device for children in the conventional manner.

As a further safety measure, cup edge 22 comes to rest within a ring-shaped collar 23, as shown in FIG. 1. This annular collar 23 is connected in a fixed manner with outside container 13 in the way of a flange. The free height of collar 23 is selected so that outside container 13 can be pressed down without any obstruction without being hindered in this stroke movement by the collar 23. On the other hand, collar 23 extends from the outside container 13 axially upwards to such an extent that cup edge 22 will come to rest within collar 23 also when no load is axially acting on outside container 13. This is shown in FIG. 1.

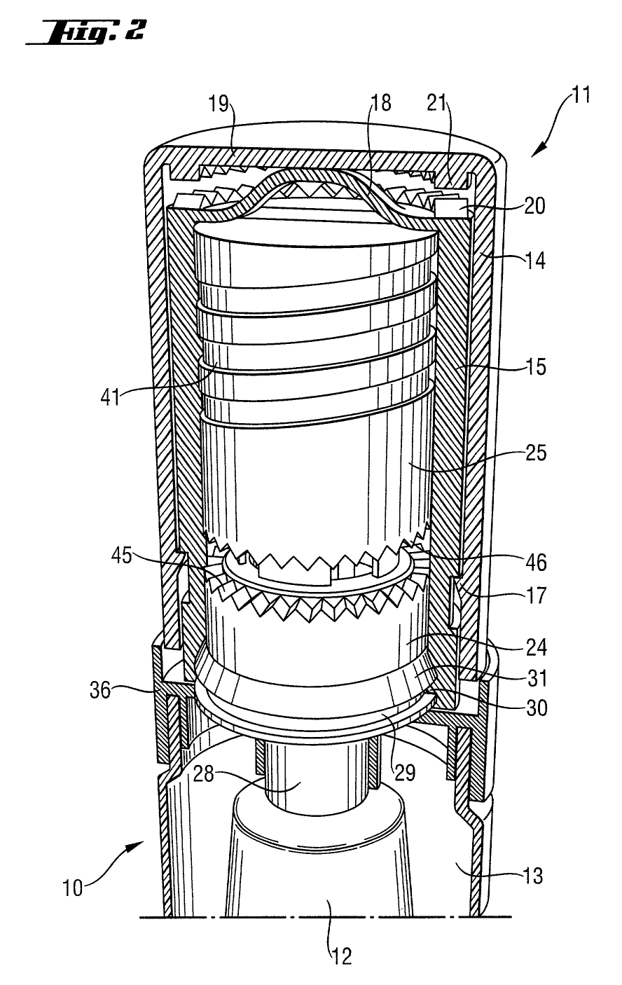

The sectional view of FIG. 2 shows that the cup-shaped, second component 15 of the screw cap encloses a first component 24 of the screw cap, said first component 24 being disposed inwards from the edge of its cup, and a component 25 for displacing the dispensing tube, said latter component 25 being arranged between said first component 24 and the bottom of the second component of the screw cap for axially displacing a dispensing tube 26 that is shown in FIG. 4 in its starting position. In the latter position, the component displacing the dispensing tube 25 rests with its lower end above a membrane 27 at a distance from the latter. Membrane 27 seals the container opening of inside container 12 in the form of a tubular container insert 28 before the container is used for the first time.

FIGS. 2, 3 and 4 show that first component 24 of the screw cap has a cylindrical shape and an outside diameter approximately corresponding with the inside diameter of the second component 15 of the screw cap. Within said inside diameter, first component 24 is guided in such a way that it can be rotated, but not displaced axially. For this purpose, an annular groove 29 is formed in the area of the lower edge of first screw cap component 24, and a bead or ring-shaped cam 30 projects from the inner wall of second screw cap component 15 into said annular groove. For the purpose of facilitating the assembly of first screw cap component 24 with the second screw cap component 15, whereby the first screw cap component 24 is inserted in second screw cap component 15 via the open edge of the cup of the latter until the ring-shaped cam 30 of the second screw cap component 15 comes to rest in the annular groove 29 of the first screw cap component 24, a cone-shaped bead 31 is formed on the outer circumference of the first screw cap component 24 in front of the annular groove 29, viewed in the installation direction. In the installed condition, bead 31 rests in a ring-shaped groove 32 extending all around and forming a groove complementing bead 31. Annular groove 32 is formed in the inner wall of the second component 15 of the screw cap.

FIG. 4 shows that after screw cap 11 has been screwed with its female thread 33 to container 10, said female thread being a right-hand thread, first component 24 of the screw cap is in engagement with a male thread 34, which is arranged fixed on the container and formed on the outer side of a cup-shaped dispensing tube holder 35. This dispensing-tube holder forms the central part of a screw cap adapter 36, which is connected in a fixed manner with outside container 13 and integrally comprises collar 23 explained above, said collar extending over outside container 13 when screw cap 11 is screwed on. In its bottom, dispensing tube holder 35 has a square central passage 37. Passage 37 is penetrated by a corresponding square section 38 of dispensing tube 26 that ends with a conical shape, tapering towards its front end, and has an edge 39 formed on the other end in the form of the cutting edge of a blade for piercing the membrane 27.

At approximately half of the length of its expanse, dispensing tube 26 comprises a dish 40, which radially projects with its annular edge from an outer side of the dispensing tube 26 and forms an axial stop for dispensing tube 26. After the dispensing tube 26 has been completely lowered into an end position, said stop comes to rest against the outer side of the bottom of the cup-shaped dispensing tube holder 35. In this final position, dispensing tube 26 is permanently interlocked with dispensing tube holder 35 by locking means (not shown).

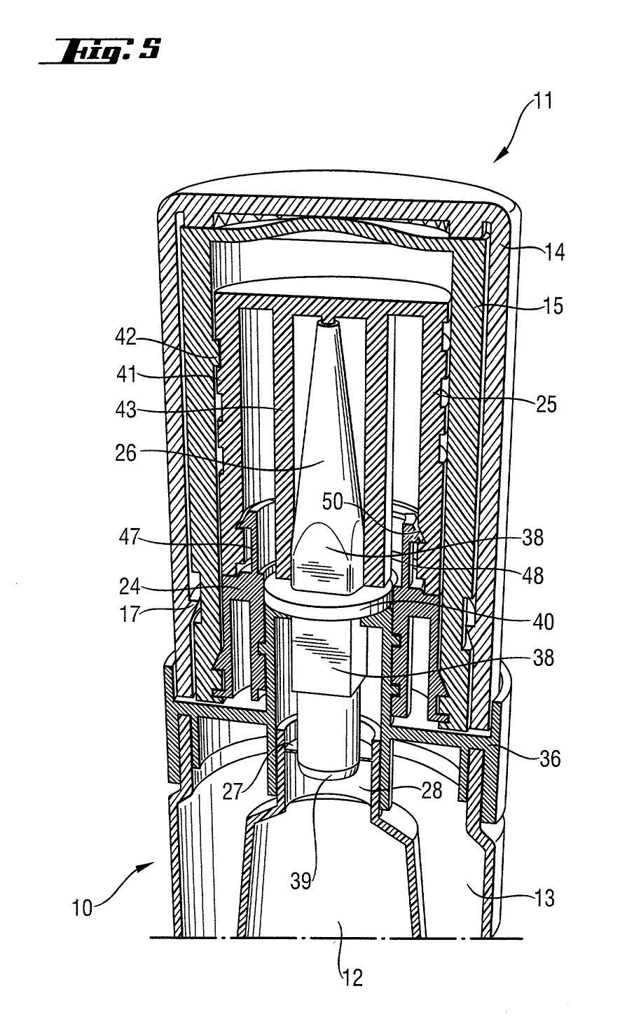

Component 25 displacing dispensing tube 26 shifts dispensing tube 26 from its staring position shown in FIG. 4, in which dispensing tube 26 is positioned at a distance above membrane 27, into an end position shown in FIG. 5. When dispensing tube 26 is in this end position, it has pierced membrane 27 and is now disposed in the container opening. Component 25 displacing the dispensing tube is driven by rotation via a second component 15 of the screw cap, or outside cover 14 joined with said cover, in the counterclockwise direction. In order to translate this rotational motion into an axial setting movement for dispensing tube 26, component 25 is in thread engagement with second component 15 of the screw cap. For this purpose, component 25 has a male thread 41 in its outer circumference that engages a female thread 42 located on the inside of the second component 15 of the screw cap.

The thread of the arrangement comprising male thread 41 and female thread 42 runs in a direction counter the arrangement comprising the female thread 33 and male thread 34, i.e. in the present case, male thread 41 and female thread 42 are realized in the form of a left-hand thread.

So as to translate the rotation of second component 15 of the screw cap (via the outside cover 14) counterclockwise into an axial stroke movement for lowering component 25 displacing the dispensing tube, and thus the dispensing tube 26 via male and female threads 41, 42, component 25 is supported on the dispensing tube with torsional strength. This connection with torsional strength is made available by a square clamping bush 43 that is tied in a fixed manner to the inner side of the bottom of the cup-shaped component 25. This connection is shown by a sectional view in FIG. 4. Clamping bush 43 is preferably formed as one single piece jointly with component 25. It has a square cross section and rests against square section 38 of dispensing tube 26. This form-locked joint between clamping bush 43 and square section 38 of dispensing tube 26 assures that component 25 is seated with torsional strength, i.e., counterclockwise rotation of second component 25 of the screw cap is translated (via the outside cover 14) into a downward displacement of component 25, in the direction of container 10.

Since clamping bush 43 is adequately long for it to abut the upper side of ring bridge 40, this downwards directed stroke movement of component 25, such movement being triggered by a counterclockwise rotation of the second component 15 of the screw cap, is translated into an axial displacement of the dispensing tube 26 from its starting position into the end position, whereby cutting blade-like end 39 of dispensing tube 26 pierces the membrane 27 in the course of this lowering movement.

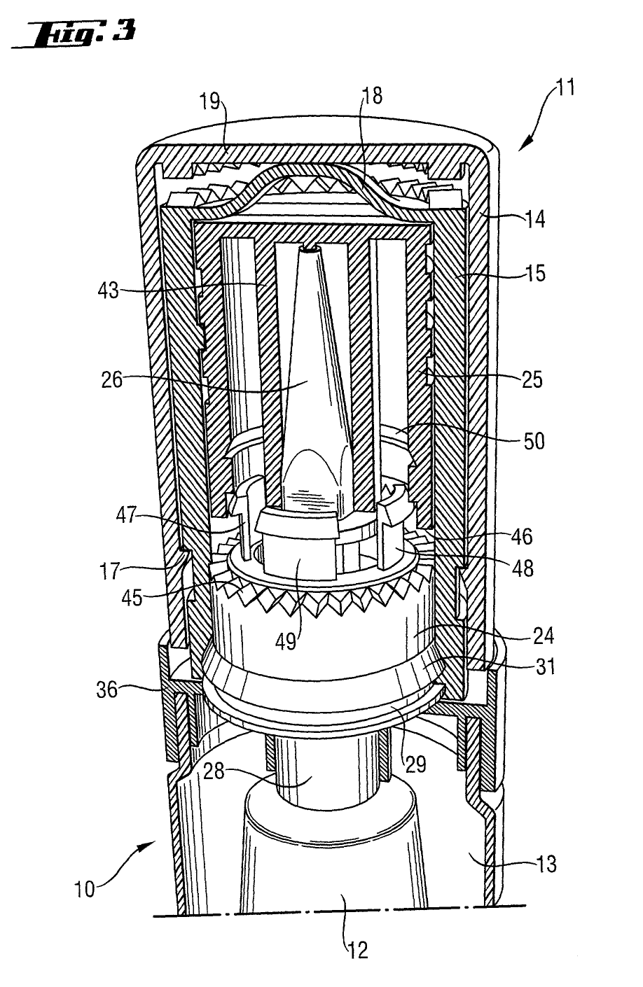

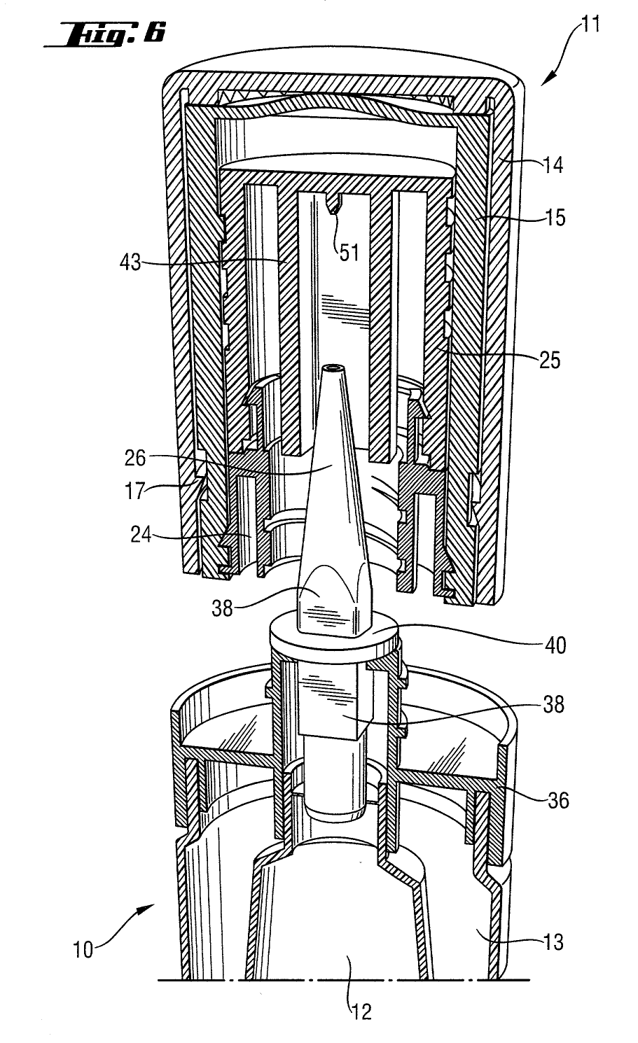

FIG. 3 shows that on the upper end of the cylindrical first component 24 of the screw cap, a toothed rim 45 is formed, projecting in the axial direction. This toothed rim is intended for engaging a complementarily formed toothed rim 46 that axially protrudes from the cup edge of the cup-shaped component 25. Toothed rims 45 and 46 engage one another after dispensing tube 26 has been lowered into its end position by component 25. Owing to this clutch-like engagement between toothed rims 45 and 46, further rotation of second screw cap component 15 (via outside cover 14) counterclockwise then leads to the removal of first screw cap component 24 by unscrewing the latter, said first component 24 being engaged with its female thread 33 with the male thread 34 of dispensing tube holder 35, which is fixed on the container. In this way, the arrangement comprising second screw cap component 15 (and outer cover 14), first screw cap component 24 and component 25 displacing the dispensing tube, said components now all being joined up with torsional strength, and thus the entire screw cap 11 is unscrewed from container 10, causing screw cap 11 to be finally detached from container 10 as it is shown in FIG. 6, so that dispensing tube 26 is now available for dispensing fluid medium from inside container 12 as intended.

To secure this combination of the individual components of the cap with the component displacing the dispensing tube in a permanent and non-releasable manner, there is an interlocked connection between component 25 and first screw cap component 24.

FIGS. 3 and 4 show that this interlocked joint comprises a large number of locking hooks (a total of three of these locking hooks 47, 48, 49 are shown in FIG. 3). These locking hooks protrude axially from the top side of cylindrical first component 24 of the screw cap and engage an annular groove 50 extending all around after component 25 displacing the dispensing tube has been completely lowered. This annular groove is formed in an inner wall of component 25 displacing the dispensing tube.

As soon as locking hooks 47 to 49 have engaged annular groove 50, component 25 is fixed with torsional strength and is axially inseparably connected with first screw cap component 24. In this condition, second screw cap component 15 is connected with torsional strength via a thread arrangement 41, 42 with the composite comprising component 25, and first screw cap component 24, so that these three components 24, 25 and 15 now have the pure function of a cover, i.e. the function of fixing the screw cap 11 that can be actuated via the safety device for children in the form of outer cover 14. However, adjusting the latter by screwing/rotating, it will no longer lead to any actuation of component 25.

A closing pin 51 protrudes centrally from the inner side of the bottom of cup-shaped component 25. Closing pin 51 has the function of a closing means for sealing the dispensing opening of dispensing tube 26, namely both when dispensing tube 26 is located in its starting position and also when it is located in its end position.

Square section 38 of dispensing tube 26 has rounded edges in the site where it is in engagement with clamping bush 43 of component 25, so that the joined composite comprising the two screw cap components 15 and 24 and component 25 can be unscrewed from the container without excessive resistance after dispensing tube 26 has been shifted into its end position. In this situation, the combination of the components causes a relative rotation between clamping bush 43 and square section 38 of dispensing tube 26 in the form of an excessive rotation, and this clamping resistance is reduced by rounding square section 38 above ring bridge 40 in an area of the edges.

Accordingly, while only a few embodiments of the present invention have been shown and described, it is obvious that many changes and modifications may be made thereunto without departing from the spirit and scope of the invention.

What is claimed is:

1. A container (10) for receiving and dispensing a fluid medium, comprising:
a container opening sealed by a pierceable membrane (27);
a dispensing tube (26) connectable with the container (10) for dispensing the fluid medium via the container opening;
a screw cap (11) for closing the dispensing tube (26);
a dispensing tube holder (35) fixed on the container, wherein the dispensing tube (26) is supported in said dispensing tube holder in an axially displaceable manner between a starting position, in which a lower end of said dispensing tube comes to rest above the non-pierced membrane (27), and an axially blocked end position, in which the lower end (39) has pierced the membrane; and
a servo-drive (15, 24, 25) for the dispensing tube (26), said servo-drive translating a movement for opening the screw cap (11) into a motion for displacing the dispensing tube (26) into the end position.

2. The container according to claim 1, further comprising a locking means for holding the dispensing tube (26) in the end position.

3. The container according to claim 1, wherein the dispensing tube (26) is supported in the dispensing tube holder (35) with torsional strength; wherein the servo-drive (15, 24, 25) is comprised of the following, coaxially arranged components: a first screw cap component (24) having a thread (33) engaged with a thread (34) fixed on the container; a second screw cap component (15) connected with the first screw cap component (24) in a rotating and axially fixed manner; and a component (25) for displacing the dispensing tube (26) by axially acting on the membrane (27), said component for displacing the dispensing tube being in thread connection (41, 42) with the second screw cap component (15) and arranged with torsional strength in relation to said second screw cap component for axially displacing the dispensing tube (26) by translating a rotational motion of the second screw cap component (15) into a stroke movement, wherein the thread connection between the second screw cap component (15) and the component (25) displacing the dispensing tube has a thread direction opposing a thread direction of the thread connection of the first screw cap component (24) with the thread (34) fixed on the container; and wherein the component (25) displacing the dispensing tube comprises a coupling (45, 46) for tying said component for displacing the dispensing tube to the first screw cap component (24) with torsional strength so as to form a closed, assembled unit jointly with the first and second screw cap components (15, 24), the first and second screw cap components being axially fixed on one another, and said assembled unit being unscrewable from the thread (34) fixed on the container when the dispensing tube (26) is in the end position.

4. The container according to claim 3, wherein the dispensing tube and dispensing tube holder are joined in a form-locked connection for supporting the dispensing tube (26) in the dispensing tube holder (35) with torsional strength.

5. The container according to claim 4, wherein the dispensing tube (26) penetrates a multi-edged, axial passage (37) in the dispensing tube holder (35) with a correspondingly multi-edged section (38).

6. The container according to claim 3, wherein the thread (34) on the container is a male thread formed on the dispensing tube holder (35).

7. The container according to claim 3, wherein the second screw cap component (15) surrounds the first screw cap component (24) and is connected in a rotating manner via an arrangement comprising an annular groove and an annular bead (29, 30).

8. The container according to claim 3, wherein the component (25) displacing the dispensing tube is contained in the second screw cap component (15) and has a male thread (41) engaged with a female thread (42) of said screw cap component (15).

9. The container according to claim 8, wherein the dispensing tube and component for displacing the dispensing tube are joined in a form-locked connection.

10. The container according to claim 9, wherein the dispensing tube (26) comprises a multi-edged section (38) engaging a clamping bush (43) of the component (25) displacing the dispensing tube.

11. The container according to claim 9, wherein the component displacing the dispensing tube is realized in a flexible manner and wherein edges of the multi-edged section of the dispensing tube are rounded, for unscrewing the assembled unit comprising the component (25) for displacing the dispensing tube and the screw cap components (15, 24), so that said form-locked joint can be overcome.

12. The container according to claim 3, further comprising a coupling (45, 46) between the component (25) displacing the dispensing tube and the first screw cap component (24), said coupling being an axially engageable toothing formed on said component displacing the dispensing tube and said first screw cap component.

13. The container according to claim 12, further comprising a device (47 to 50) for axially fixing the component (25) for displacing the dispensing tube on the first screw cap component (24), for connecting said two components (24 and 25) with torsional strength when the coupling (45, 46) is engaged.

14. The container according to claim 13, wherein the device (47 to 50) for axially fixing the component (25) for displacing the dispensing tube on the first screw cap component (24) is realized in the form of locking means.

15. The container according to claim 8, wherein the component (25) displacing the dispensing tube has the shape of a cup; and wherein the first screw cap component (24) is generally cylindrical and adjoins an edge of the cup of the component (25) displacing the dispensing tube.

16. The container according to claim 15, wherein the clamping bush (43) is realized in the form of clamping bridges protruding from the bottom of the cup of the component (25) displacing the dispensing tube, for engaging a multi-edged section (38) of the dispensing tube.

17. The container according to claim 16, wherein for axial displacement of the dispensing tube by means of the component (25) displacing the dispensing tube, said dispensing tube comprises a ring bridge (40) located below an area of the multi-edged section (38).

18. The container according to claim 15, further comprising toothings (45, 46) formed on an edge of the cup of the component (25) displacing the dispensing tube, and on an annular edge of the cylindrical first screw cap component (24) pointing at said edge of the cup.

19. The container according to claim 15, further comprising locking noses or locking hooks (47, 48, 49) projecting upwards from an end of the first screw cap component (24), pointing at the component (25) displacing the dispensing tube, for engaging an annular groove (50) in an inner wall of the component (25) displacing the dispensing tube.

20. The container according to claim 15, further comprising a closing pin (51) for the dispensing tube (26) protruding from a bottom of the cup-shaped component (25) displacing the dispensing tube.

21. The container according to claim 15, wherein the second screw cap component (15) has the shape of a cup and surrounds both the cup-shaped component (25) displacing the dispensing tube and the first screw cap component (24) adjoining said cup-shaped component (25).

22. The container according to claim 21, further comprising a safety device for children in the form of a cup-shaped external cover (14) extending over the cup-shaped second screw cap component (15) and connectable therewith with torsional strength via a coupling (20, 21), said coupling being movable from a disengaged position, in which the external cover is connected with the second screw cap component (15) in a freely rotating manner, into its engaged position by axially shifting the external cover (14) against the second screw cap component (15), said coupling being retained in its disengaged position by a spring means (18).

23. The container according to claim 22, wherein the spring means is arranged between a bottom of the external cover (14) and a bottom of the second screw cap component (15).

24. The container according to claim 22, wherein the coupling (20, 21) comprises mutually engageable protrusions.
